(19) United States
(12) Patent Application Publication
(10) Pub. No.: US 2008/0178708 A1
(43) Pub. Date: Jul. 31, 2008

(54) DISTRESSING TOOL

(75) Inventors: Lisa Marie Wheat, Draper, UT (US); Gerardo D. Ayala, Provo, UT (US)

Correspondence Address: LISA MARIE WHEAT, 13018 GLACIER POINT CIRCLE, DRAPER, UT, 84020, US

(73) Assignee: PROVO CRAFT AND NOVELTY, INC., Spanish Fork, UT (US)

(21) Appl. No.: 11/626,955

(22) Filed: Jan. 25, 2007

(51) Int. Cl. B25D 1/02

(52) U.S. Cl. 81/26; 81/20

(57) ABSTRACT

A distressing tool comprises a handle configured for grasping by a user, a head member coupled to the distal end of the handle and at least one distressing head coupled to said head member, said distressing head having at least one protruding pattern formed thereon. The protruding pattern is configured to simulate an existing object such as a grate, worm holes, threads, bolts, worm burrows, slices gouges, pan head screws, chains and nails.

### CROSS-REFERENCE TO RELATED APPLICATIONS

This application claims priority to U.S. Provisional Patent Application Ser. No. 60/761,139, filed on Jan. 25, 2006.

### BACKGROUND OF THE INVENTION

1. Field of the Invention

The present invention relates generally to hammers, and more specifically to a hammer that provides distressing features that allow a user to generate a distressed look on wood products, such as furniture.

2. Background of the Prior Art

Hammers are generally known in the art and have been available for centuries. More recently, however, there has been a desire to create a “distressed” look, especially to various furniture pieces (such as wood tables and chairs), kitchen cabinets, picture frames and other items made of wood, to give the appearance that the item is much older than it actual is. This design trend has led to an entire industry of distressed-looking furniture, cabinets and other wood products that are sold in virtually every retail store that sells such products.

It is often desirable to create distressed furniture or other items out of items currently in one's own possession. That is, for example, rather than replacing a piece of furniture with a new one having a desired look, it may be equally desirable and less expensive to refinish the existing piece of furniture to have the desired look. As such, if one is capable of refinishing the furniture, the end result may be what the person desires at a cost significantly less than what a new furniture piece may cost. Additionally, the market for unfinished furniture or items has been expanded by those seeking to create a distressed look to a new item that has not been finished.

Current methods for “distressing” items include using a conventional claw hammer to create dents in the surface to give the appearance that the furniture piece has been used over the years, even though the furniture piece may be relatively new. This method of false antiquing or aging of items is what is commonly referred to as “distressing.” It is also common to use other items, other than a conventional claw hammer, to create dents in the items, such as heavy metal chains. Thus, in order to create a desired distressed look, it may take several items used in combination to create the desired effect.

Thus, there exists a need in the art to provide a tool that allows one to create the appearance of the use of various items to distress a wood item while only using a single tool.

### SUMMARY OF THE INVENTION

The present invention is an apparatus to be used in the process of distressing surfaces of decorative objects including, but not limited to furniture, picture frames, cabinets, shelves and other items. In the finishing of such items, it is sometimes desirable to distress the surface of the wood to create and/or enhance a rustic or antique feel.

The invention comprises an impact hand tool designed to facilitate the distressing of decorative objects. The tool includes one or more impact heads that are attached to a handle in a configuration similar to a conventional hammer. The impact heads are interchangeable and thus removable and replaceable from the handle of the tool. Each impact head is provided with a different surface pattern to create different distressed effect.

In one embodiment, the tool comprises an elongate shaft to which one or more heads may be attached or integrally formed therewith.

In another embodiment, the butt end of the shaft of the tool comprises a distressing head.

In another embodiment of the invention, the distressing head has a mallet-type configuration with a pair of opposing distressing heads attached to the handle. The head is threadedly attached to the handle.

### BRIEF DESCRIPTION OF THE DRAWINGS

FIG. 1 is a side view of a first embodiment of a distressing tool in accordance with the principles of the present invention.

FIG. 2 is an exploded perspective view of the distressing tool illustrated in FIG. 1.

FIG. 3A is a perspective side view of a head member of a distressing tool in accordance with the principles of the present invention.

FIG. 3B is a top side vies of the head member illustrated in FIG. 3A.

FIG. 3C is a cross-sectional side view of the head member illustrated in FIG. 3A.

FIG. 4A is a perspective side view of a handle for a distressing tool in accordance with the principles of the present invention.

FIG. 4B is a top side view of the handle shown in FIG. 4A.

FIG. 4C is a side view of the handle shown in FIG. 4A.

FIG. 5 is an exploded perspective side view of an alternative embodiment of a distressing tool in accordance with the principles of the present invention.

FIG. 6 is a side view of an alternative embodiment of a distressing head in accordance with the principles of the present invention.

FIGS. 7A-16B illustrate several embodiments of distressing heads having various patterns formed therein.

FIG. 17 is a side view of an alternate embodiment of a distressing tool according to the principles of the present invention.

### DETAILED DESCRIPTION OF THE ILLUSTRATED EMBODIMENTS

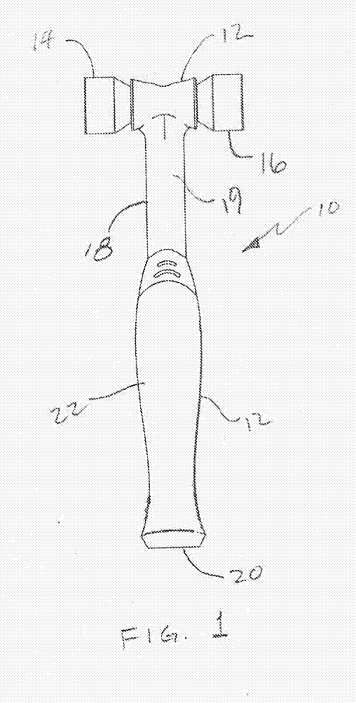

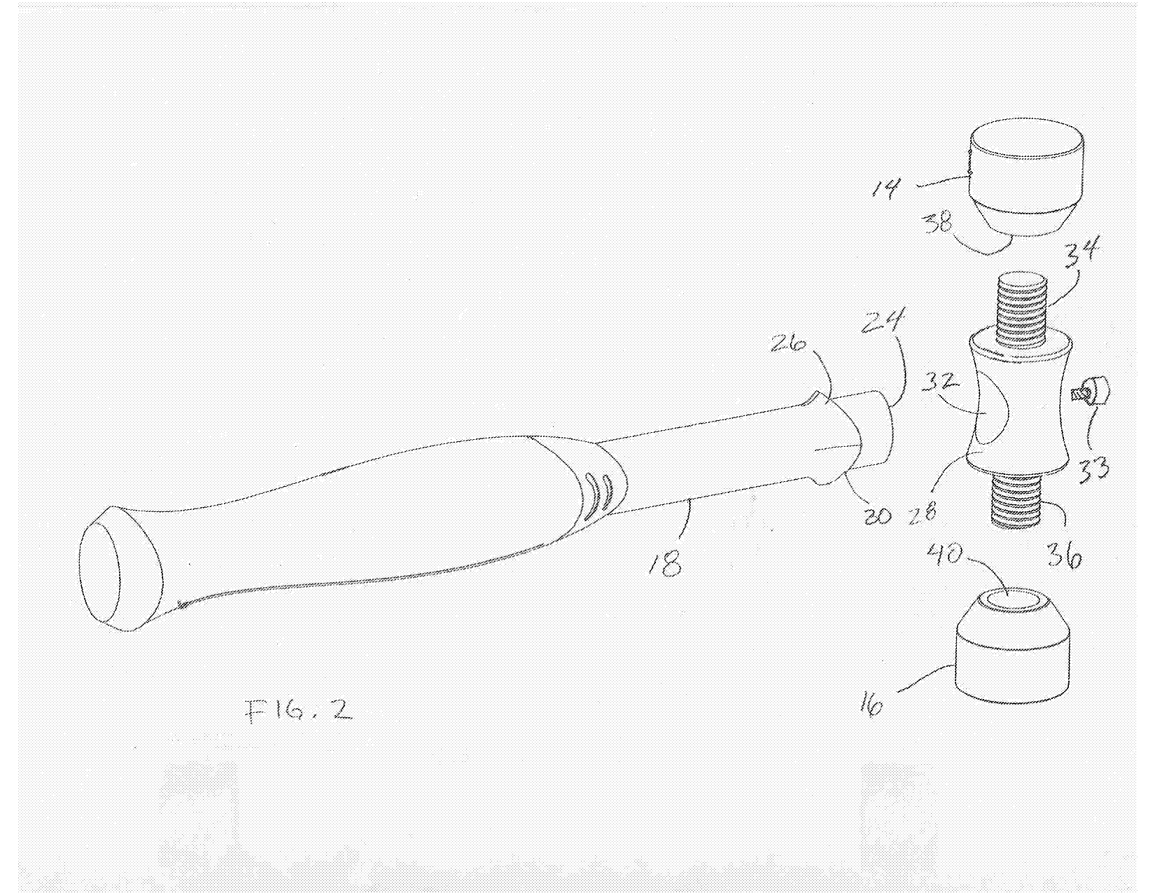

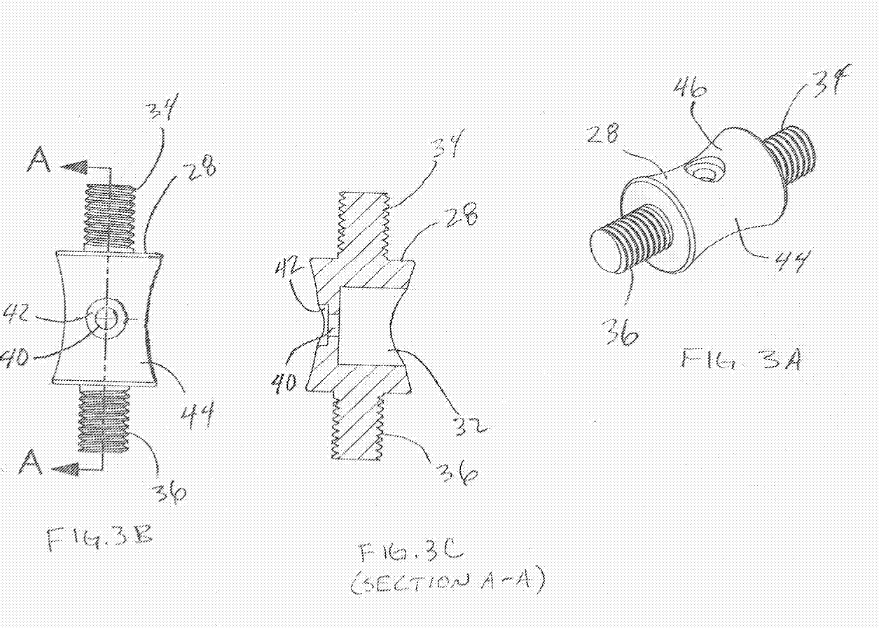

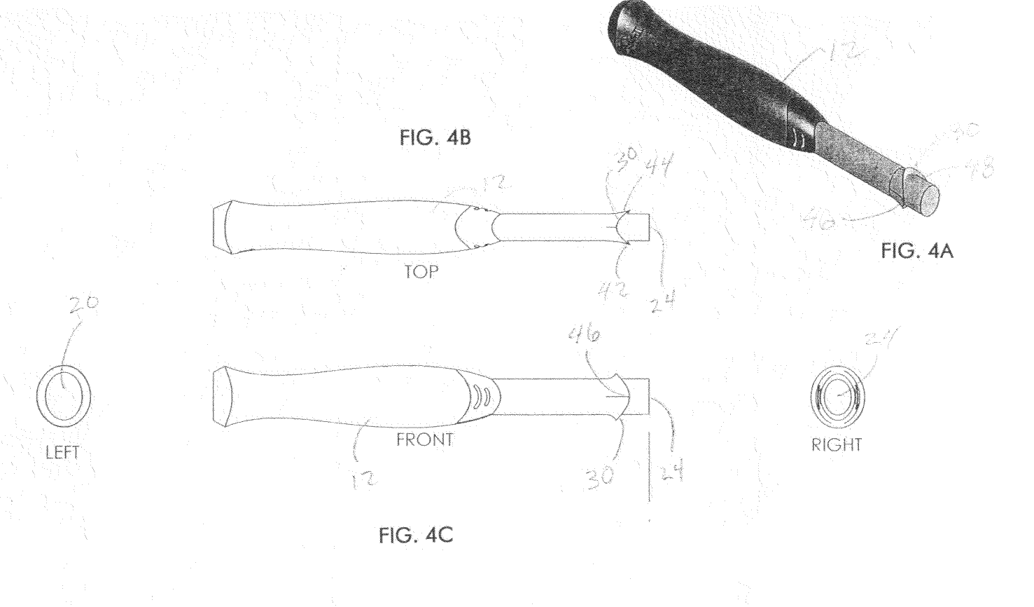

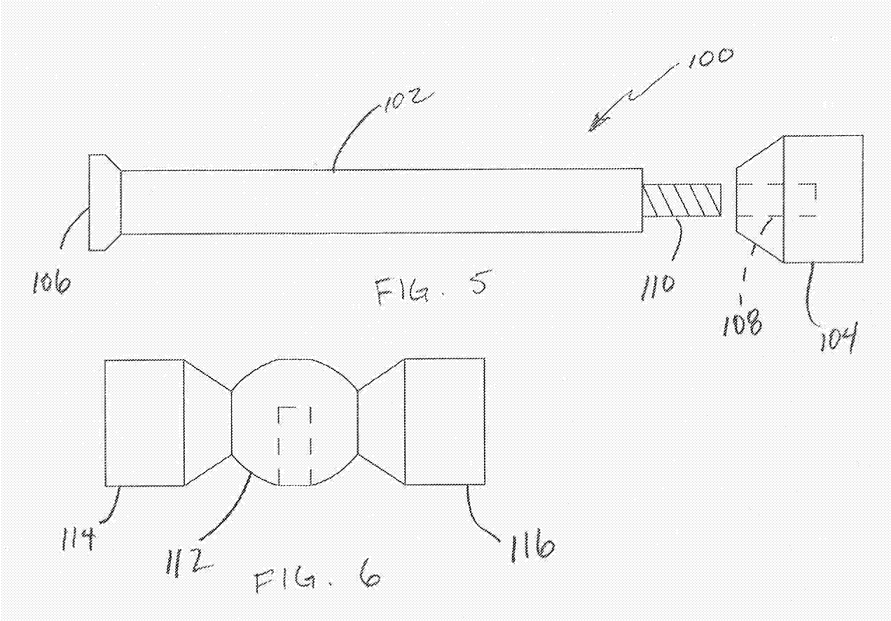

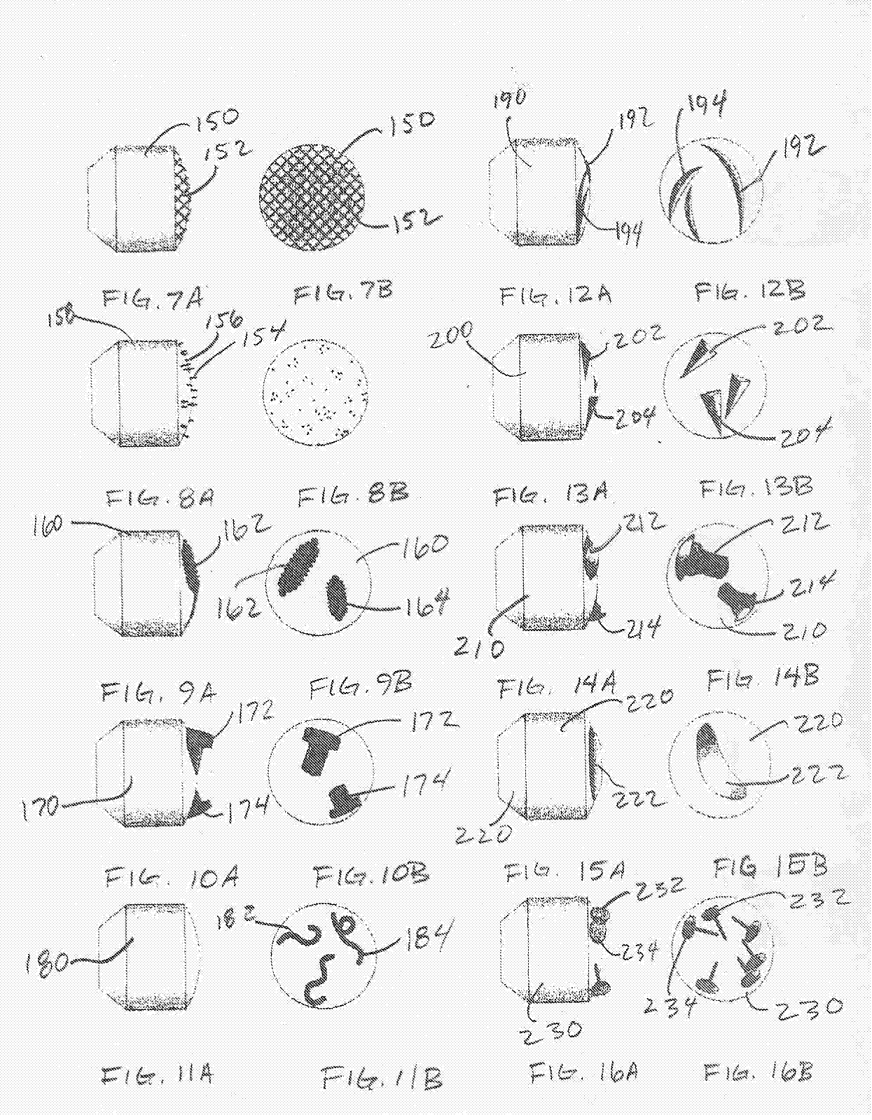

FIG. 1 is illustrates a distressing tool, generally indicated at 10, in accordance with the principles of the present invention. The tool 10 is comprised of a handle portion 12 and a head portion 12 two which a pair of distressing heads 14 and 16 are attached. Each distressing head 14 and 16 is provided with a distinct distressing pattern (not shown) to create a distinct distressing feature on an object impacted by one of the distressing heads 14 and 16.

The handle portion 12 includes a shaft 18 that extends from the head portion 12 to the proximal end 20 and is comprised of a rigid material such as solid cast, milled or hollow tube steel. The shaft 18 may also be comprised of wood, plastic or fiberglass. The shaft 18 is partially covered by a gripping sleeve 22 comprised of a flexible material such as rubber that may be molded over the shaft 18 to provide a grasping portion for the hand of a user. The distal end portion 19 is covered with a plastic covering, such as a polypropylene material, that is formed over the end to cover the handle and head portion to make them appear as a single unitary component.

As shown in FIG. 2, the distal end 24 of the shaft 18 is provided with a flared portion 26 contoured to mate with the head member 28. The flared portion 26 is spaced from the cylindrical distal end 24 and provides an abutment surface 30 against which the head member 28 will abut upon assemble. The contour of the abutment surface 30 prevents the head member 28 from rotating upon the cylindrical end 24. The flared portion may be molded into the shaft 18. The head member 28 may be mated to the distal cylindrical end by engaging the distal cylindrical end 24 with the bore 32 that is transversely formed in the head 28. The head member 28 may be held to the distal cylindrical end 24 by friction fit and/or attached with a threaded fastener 33 that engages through the head member 28 and into a threaded hole (not visible) in the distal end 24 of the handle 18 that couples the head member 28 to the end 24.

Attached to the head member 28 is a pair of distressing heads 14 and 16. The distressing heads are each threadedly attached to the head member 28. The head member 28 is provided with a pair of longitudinally extending threaded shafts 34 and 36 that are configured to threadedly engage with internally threaded bores 38 and 40, respectively, of the distressing heads 14 and 16.

As further shown in FIGS. 3A-3C, the head member 28 is comprised of a single piece of material, such as hardened steel, having first and second longitudinally extending threaded shafts 34 and 36. As best illustrated in FIG. 3C, which shows a cross-section view of the head member 28, the head member 28 defines a transversely extending bore 32 that partially extends into one side of the head member 28. The bore 32 is sized and shaped to receive the distal end of the handle (previously described). To hold the head member 28 to the handle, a second transversely extending bore 40 extends into the head member 28 at a side opposite to the side of the first bore 32. The second bore 40 is generally concentric with the first bore 32 and is in communication therewith. The second bore 40 has a countersunk portion 42 for receiving the head of a threaded fastener (not shown). The threaded fastener would thus extend through the bore 40 and into a threaded opening in the distal end of the handle.

The body 44 of the head member 28 has a generally cylindrical, convex contour 46 for mating with the abutment feature at the distal end of the handle previously described herein. The contour 46 is configured to better engage with the abutment surface to prevent rotation of the head member 28 relative to the shaft when assembled thereto.

As shown in FIGS. 4A-4C, the contoured abutment surface 30 in combination with the cylindrical distal end 24 forms a shape similar that a top hat having a cylindrical top with a curved brim. The surface 30 has opposing sides 42 and 44 that have portions that are closer to the distal end than portions of opposing sides 46 and 48. This non-linear contour allows the abutment surface 30 to retain the relative position of the head member 28 once seated on the distal end 24.

FIG. 5 is an exploded view of another embodiment of a distressing tool, generally indicated at 100, in accordance with the principles of the present invention. The tool 100 is comprised of a handle 102 and a distressing head 104 configured for attachment thereto. The handle 102 is comprised of an elongate shaft that may be comprised of round or hex cross-sectionally shaped material, such as cast solid steel, hollow steel tube, milled steel, fiberglass, wood, plastic or other materials known in the art. The proximal end 106 of the handle 102 is provided with a larger diameter portion configured to act as an impact end such that the tool 100 may be impacted by a conventional hammer (not shown) in a manner similar to the use of a hammer and chisel. It is also contemplated that the head and handle may be formed from a single unitary piece of material or welded together after manufacturing.

The distressing head 104 is provided with a longitudinally extending bore 108 for receiving and engaging with the threaded end 110 of the handle 102. As further illustrated in FIG. 6, a distressing head 112 configured for attachment to the handle 102 is provided with a pair of distressing heads 114 and 116. Each distressing head is provided with different distressing features.

As illustrated in FIGS. 7A and 7B, a distressing head 150 is provided with a raised cross-hatched grater pattern 152 formed thereon. Reference herein to “pattern” refers to the raised features formed on the distressing head. When used with the distressing tool of the present invention, the head 150 will imprint the grater pattern on a piece of wood when struck with head 150. By providing interchangeable heads with different patterns, the distressing tool of the present invention can be employed to provided different distressing patterns or looks by denting a wood object when struck.

FIGS. 8A through 16B illustrated various examples of distressing patterns that may be provided on a distressing head in accordance with the principles of the present invention. Each of the distressing features provide partial replicas of existing structures, such as screw heads, sections of chain, nails, or other structures or may have a shape configured to create a dent similar to that caused during the normal course of use or age, such as to create a gash, slice, worm holes and the like. As shown in FIG. 8A, the appearance of worm holes may be created in a piece of wood by providing individual spikes 154 on the impacting surface 156 of the distressing head 158. As further illustrated, the impacting surface 156 is convex in shape so as to change the effective height of the spikes 154 even though they may each be of similar height relative to the surface 156.

FIGS. 9A and 9B illustrate a distressing head 160 in which the distressing features 162 and 164 simulate the side of threads of a bolt or screw.

FIGS. 10A and 10B illustrate a distressing head 170 in which the distressing features 172 and 174 simulate the heads of bolts.

FIGS. 11A and 11B illustrate a distressing head 180 in which the distressing features 182 and 184 simulate worm burrows.

FIGS. 12A and 12B illustrate a distressing head 190 in which the distressing features 192 and 194 to cut slices in the surface of the wood.

FIGS. 13A and 13B illustrate a distressing head 200 in which the distressing features 202 and 204 to form gouges in the surface of the wood.

FIGS. 14A and 14B illustrate a distressing head 210 in which the distressing features 212 and 214 simulate pan head bolts.

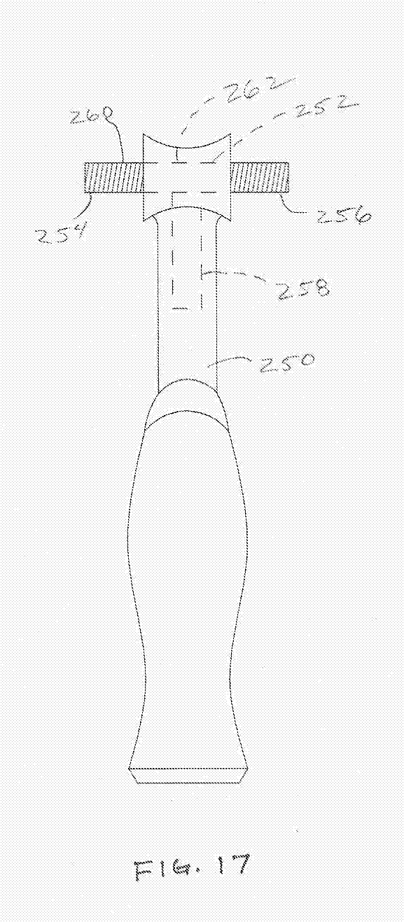

FIGS. 15A and 15B illustrate a distressing head 220 in which the distressing features 222 and 224 simulate the impact of a link of chain.

FIGS. 16A and 16B illustrate a distressing head 230 in which the distressing features 232 and 234 simulate nails.

Finally, as shown in FIG. 17, the tool handle 250 may comprise an overmolded component that is molded over and secured to a head member 252, as may be accomplished with any of the various molding processes known in the art. The head member 252 is comprised of a “T” shaped structure comprised of two shafts perpendicularly attached. The head member 252 may be cast as a single piece or comprised of two pieces that are welded or mechanically attached. The lateral ends 254 and 256 are threaded to accept distressing heads as previously shown and described. The overmolded handle may be comprised of polypropylene or other materials known in the art that are strong and can withstand stresses generated by the impact of the distressing heads when struck. The base portion 258 of the head member 252 depends perpendicularly from the cross-member portion 260 and extends a distance into the handle 250. The base portion 258 extends into the gripping portion 251 of the handle 250 so as to provide a solid structure for supporting the distressing heads (not shown) when striking. The handle 250, including the gripping portion 251, surrounds the base portion 258 and the mid portion 262 of the cross-member portion 260. Thus, the overmolded handle 250 is formed around the mid portion 262 of the head member 252 to provide an esthetically pleasing exterior while providing maximum strength between the cross-member portion 252 and base portion 258 as a single unitary component.

It is understood that the terminology used herein is used for the purpose of describing particular embodiments only and is not intended to limit the scope of the present invention. It is also understood that, as used herein and in the appended claims, the singular forms “a,” “an,” and “the” include plural reference, unless the context clearly dictates otherwise.

Unless defined otherwise, all technical and scientific terms used herein have the same meanings as commonly understood by one of ordinary skill in the art to which this invention belongs. While various methods, compositions, and materials of the present invention are described herein, any methods and materials similar or equivalent to those described herein may by used in the practice or testing of the present invention. All references cited herein are incorporated by reference in their entirety and for all purposes.

While the foregoing advantages of the present invention are manifested in the illustrated embodiments of the invention, a variety of changes can be made to the configuration, design and construction of the invention to achieve those advantages. Hence, reference herein to specific details of the structure and function of the present invention is by way of example only and not by way of limitation.

What is claimed is:

1. An apparatus for creating distressing patterns, comprising:
a handle portion configured for grasping by a user and having a distal end and a proximal end;
a head portion coupled to said distal end;
at least one distressing head coupled to said head portion, said distressing head having at least one pattern thereon, said at least one pattern configured to simulate an existing object.

2. The apparatus of claim 1, wherein said handle portion defines an abutment surface proximate a distal end thereof for abutting the head portion.

3. The apparatus of claim 2, wherein said abutment surface has a contour to match a contour of said head portion to prevent said head portion from rotating relative to said handle portion.

4. The apparatus of claim 1, wherein said head portion comprises a pair of opposing attachment structures and said at least one distressing head comprises a pair of distressing heads, each releasably attached to one of said pair of opposing attachment structures.

5. The apparatus of claim 1, wherein said at least on distressing head includes at least one pattern selected from the group comprising a grate, worm holes, threads, bolts, worm burrows, slices gouges, pan head screws, chains and nails.

6. The apparatus of claim 1, wherein said head portion is integrally formed with said handle portion.

7. The apparatus of claim 6, wherein said distressing head is integrally formed with said head portion and said proximal end of said handle portion provides an impact end for striking.

8. The apparatus of claim 1, wherein said handle portion further includes a gripping sleeve disposed over a portion of said handle portion for grasping by a user.

9. The apparatus of claim 1, wherein said head portion defines a first transversely extending bore for receiving a distal end of said handle portion and a second smaller transversely extending bore for receiving a threaded fastener, said threaded fastener engaging with a threaded hole in said distal end of said handle for coupling said head portion to said handle portion.

10. A distressing tool, comprising:
a handle configured for grasping by a user and having a distal end and a proximal end;
a head member coupled to said distal end of said handle;
at least one distressing head coupled to said head member, said distressing head having at least one protruding pattern formed thereon, said at least one protruding pattern configured to simulate an existing object.

11. The apparatus of claim 10, wherein said head member includes a pair of opposing threads and said at least one distressing head comprises a pair of distressing heads, each threadedly coupled to one of said pair of opposing threads of said head member.

12. The apparatus of claim 10, wherein said at least on distressing head includes at least one protruding pattern selected from the group comprising a grate, worm holes, threads, bolts, worm burrows, slices gouges, pan head screws, chains and nails.

13. The apparatus of claim 10, wherein said handle further includes a gripping sleeve disposed over a portion of said handle for grasping by a user.

14. The apparatus of claim 10, wherein said head member defines a first transversely extending bore for receiving a distal end of said handle portion and a second smaller transversely extending bore for receiving a fastener, said fastener engaging with said distal end of said handle for coupling said head portion to said handle portion.
